(19) United States
(12) Patent Application Publication
(10) Pub. No.: US 2026/0134003 A1
(43) Pub. Date: May 14, 2026

(54) ACCURACY EVALUATION OF QUERIES USING LANGUAGE MODELS

(71) Applicant: INTERNATIONAL BUSINESS MACHINES CORPORATION, ARMONK, NY (US)

(72) Inventors: Jesus Manuel Olivera, New York, NY (US); Manisha Sri Solipuram, New York, NY (US)

(21) Appl. No.: 18/941,743

(22) Filed: Nov. 8, 2024

(51) Int. Cl. G06F 16/332; G06F 40/30

(52) U.S. Cl. CPC G06F 16/3329; G06F 40/30

(57) ABSTRACT

A method, computer system, and a computer program product are provided for evaluating accuracy of a large language model (LLM). A user query is received, and a plurality of output is obtained that is generated by an LLM as a response to the user query. The accuracy of each output generated is determined by extracting domain context from the user query and each plurality of output generated by said LLM to generating at least a model input. The plurality of LLM outputs is compared to the at least one model input generated based on a semantic analysis. The plurality of LLM outputs is ranked for accuracy based on the comparison. The ranking is made based associated weights generated for each of the plurality of LLM outputs. A final response output is generated based on the ranking and a response is provided to the user query.

### BACKGROUND

The present invention relates generally to data management and more particularly to techniques for evaluating accuracy of queries using large language models.

Generative artificial intelligence (AI) and Large Language Models (LLMs) are in many applications today. LLMs provide deep learning in order to understand how characters, words and sentences function together. To ensure accuracy and reliability, LLMs are trained via tuning.

Natural Language Understanding (NLU) and Natural Language Processing (NLP) are used in conjunction with LLMs. NLP and NLU have undergone a remarkable evolution over the years. However, with advancements in machine learning and deep learning, particularly with the rise of neural networks, NLU and NLP have seen a paradigm shift. These approaches have enabled systems to learn the intricate patterns and nuances of language, allowing for more sophisticated tasks such as sentiment analysis, machine translation, and question answering.

Ensuring fidelity and coherence of outputs are paramount for language models. Consequently, continuous effort is provided to ensure reliability of outputs.

### SUMMARY

Embodiments of the present invention disclose a method, computer system, and a computer program product for evaluating accuracy of a large language model (LLM. A user query is received, and a plurality of output is obtained that is generated by an LLM as a response to the user query. The accuracy of each output generated is determined by extracting domain context from the user query and each plurality of output generated by said LLM to generating at least a model input. The plurality of LLM outputs is compared to at least one model input generated based on a semantic analysis. The plurality of LLM outputs is ranked for accuracy based on the comparison. The ranking is made based associated weights generated for each of the plurality of LLM outputs. A final response output is generated based on the ranking and a response is provided to the user query.

### BRIEF DESCRIPTION OF THE SEVERAL VIEWS OF THE DRAWINGS

These and other objects, features and advantages of the present invention will become apparent from the following detailed description of illustrative embodiments thereof, which may be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 provides an operational flowchart for a process which provides for an accuracy validation mechanism, according to an embodiment;

FIG. 3a provides a block diagram illustration of the embodiment of FIG. 2;

FIG. 3b provides a more detailed block diagram of the embodiment of FIG. 3a;

FIG. 4 is an illustration of a block diagram providing for flow of the Domain Concept process, according to one embodiment;

FIG. 5 provides a block diagram illustration of using Domain Context in a Database embedding scenario, according to one embodiment; and

FIG. 6 provides a block diagram of a conceptual example of an instance dealing with a regulatory compliance regime, according to one embodiment.

### DETAILED DESCRIPTION

Detailed embodiments of the claimed structures and methods may be disclosed herein; however, it can be understood that the disclosed embodiments may be merely illustrative of the claimed structures and methods that may be embodied in various forms. This invention may, however, be embodied in many different forms and should not be construed as limited to the exemplary embodiments set forth herein. Rather, these exemplary embodiments may be provided so that this disclosure will be thorough and complete and will fully convey the scope of this invention to those skilled in the art. In the description, details of well-known features and techniques may be omitted to avoid unnecessarily obscuring the presented embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

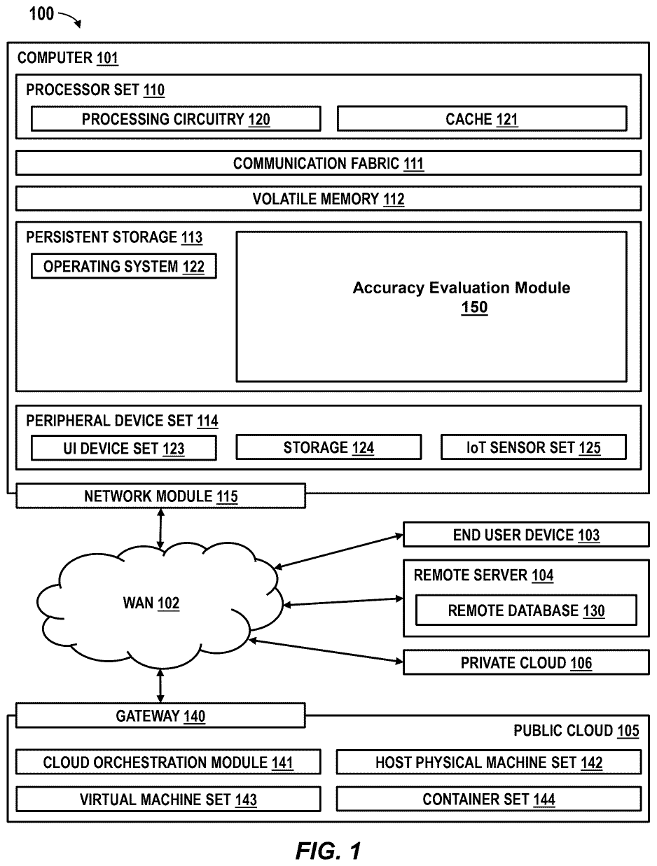

FIG. 1 provides a block diagram of a computing environment 100. The computing environment 100 contains an example of an environment for the execution of at least some of the computer code involved in performing the inventive methods, such as code change differentiator which is capable of providing An Accurate Evaluation Module (150). In addition to this block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 of FIG. 1 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some or all of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As discussed earlier, generative artificial intelligence (AI) and Large Language Models (LLMs) are in many applications today. LLMs provide deep learning in order to understand how characters, words and sentences function together. To ensure accuracy and reliability, LLMs are trained via tuning.

Natural Language Understanding (NLU) and Natural Language Processing (NLP) are used in conjunction with LLMs. Initially, NLP focused on rule-based systems and statistical approaches to understand and generate human language. However, with advancements in machine learning and deep learning, particularly with the rise of neural networks, NLU and NLP have seen a paradigm shift. These approaches have enabled systems to learn the intricate patterns and nuances of language, allowing for more sophisticated tasks such as sentiment analysis, machine translation, and question answering.

With the advent of generative AI and Large Language Models (LLMs), organizations are delving deeper into validation mechanisms to ensure the accuracy and reliability of the outputs generated. These LLMs, trained on vast amounts of data, have the capability to produce remarkably human-like text. However, ensuring the fidelity and coherence of these outputs is paramount. Validation mechanisms involve assessing the outputs from various perspectives, including linguistic coherence, factual accuracy, and domain relevance. Organizations are exploring techniques such as human evaluation, adversarial testing, and fine-tuning on specific domains to enhance the accuracy and performance of LLMs.

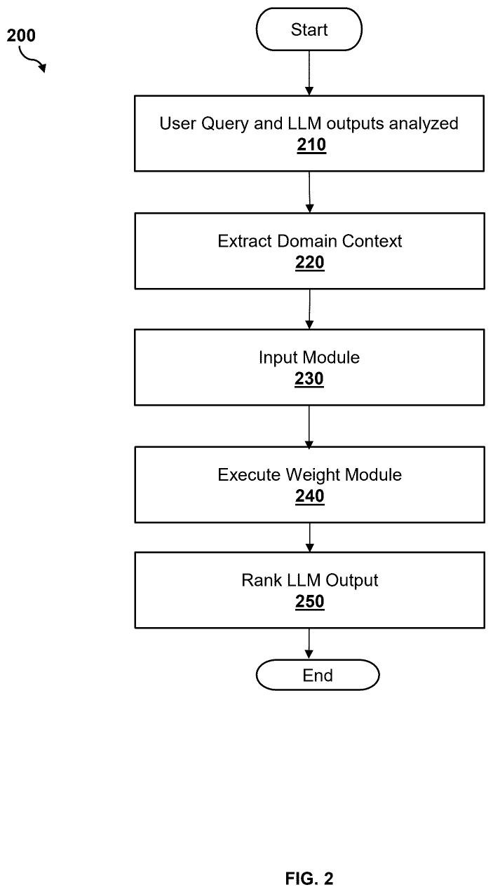

From a tuning and performance perspective, organizations are increasingly focusing on fine-tuning LLMs to specific tasks and domains to improve their accuracy and effectiveness. Fine-tuning involves retraining pre-trained models on domain-specific data or adjusting model parameters to better suit the desired task. Additionally, techniques such as knowledge distillation, where a large pre-trained model transfers its knowledge to a smaller, task-specific model, are gaining traction for improving efficiency without sacrificing accuracy. Overall, the evolution of NLU and NLP, coupled with the emergence of generative AI and LLMs, has spurred organizations to develop robust validation mechanisms and explore fine-tuning strategies to enhance the accuracy and performance of language models in various applications. FIG. 2 provides a process 200 which provides for an accuracy validation mechanism against LLM outputs when evaluating the best match for a user query.

FIG. 2 provides a flow chart illustration of the process 200. In Step 210, relevant domain context is extracted for the LLM outputs. According to one embodiment, the user queries and LLM outputs can be both analyzed and used.

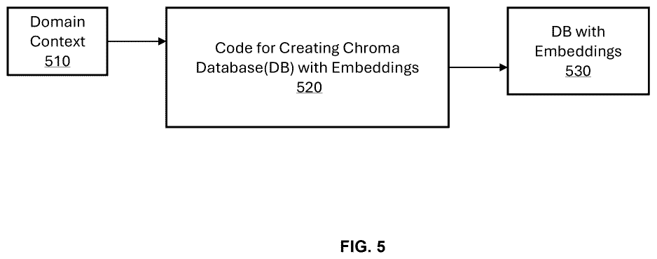

In Step 220, domain context is extracted. According to one embodiment, Domain specific context is extracted after embedded model used for similarity analysis. The domain context may include a glossary, lemmatization, and human in the loop (HITL) context. The glossary is a dictionary of terms or phrases pulled of similar meaning to each other, created for relevant terms in the LLM output. According to one embodiment, the Domain specific module context extracted after embedded model used for similarity analysis. In one embodiment, a “Pre-Processing Lemmatization” process can be conducted to reduce words to their roots, which may be included in the domain context. A more detailed explanation is provided in conjunction with FIG. 5.

In Step 230, the input module is analyzed. According to one embodiment, the input module and the LLM output are compared in semantic similarity to similar outputs to determine which it has the most semantic similarity to each other.

In Step 240, a weight module is used to generate weights. The weight module factors in the outputs from the first step (domain context) and second step (input module). The weight module takes the domain context and the input module/semantic similarity data to output a ranking of the most relevant to least relevant answers to the user query.

In Step 250, the wights generated are used to rank LLM output. According to one embodiment, different alternate ways can be used to organize the ranked LLMs. For example, LLM output can be provided in a descending order.

In one embodiment, the Weight module can be ordered in the following manner:
1) a Named Entity Recognition and Classification (NERC) is performed that can include the following restrictions or limitations:
   Extracting entities from input to match and classify them, example:
      Regulation Description/control description:
      Aligning entities with similar entities: example NLTK WordNet: synonyms, abbreviations, slang, language translations
      Entity classification: (Classify entities: example NLTK WordNet: synonyms, abbreviations, slang, language translations; and Create Dictionaries from classification and list of entity and synonyms)
      Embedding Word2Vec-Embed every dictionary
   Extract entities from inputs-to-be-matched and classify them, example:
   Regulation Description/control description: (Align entities with similar entities: example NLTK WordNet: synonyms, abbreviations, slang, language translations)
      Entity classification: (Classify entities: example NLTK WordNet: synonyms, abbreviations, slang, language translations); and Creating Dictionaries from classification and list of entity and synonyms
      Embedding Word2Vec (Embed every dictionary)
   Cosine Similarity:
      Input vs each inputs-to-be-matched (example—Order inputs-to-be-matched in descending order);
   Cluster Embeddings:
      K-means:
         Z score; Round Z scores; Arbitrary rounded threshold of 1 to intensify characterization of “high” and “low” similarity; Replace positive numbers with “high” and every negative with low; Order inputs-to-be-matched in descending order related to count of high vs low
      Rand Index and Adjusted Rand Index for each input against each of the inputs-to-be-matched (ARI):
         The higher the ARI the more similar (−1 to 1)
   Append all outputs to data frame
   Each input-to-be-matched is ranked in descending order based on K-means & ARI analysis.

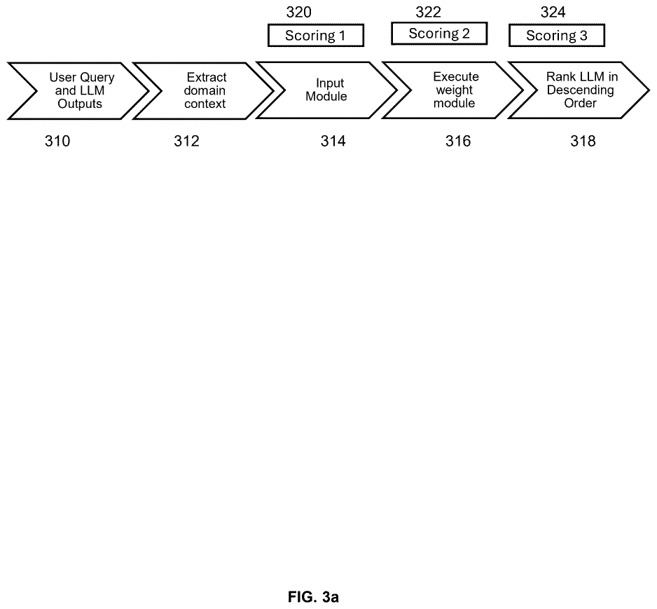

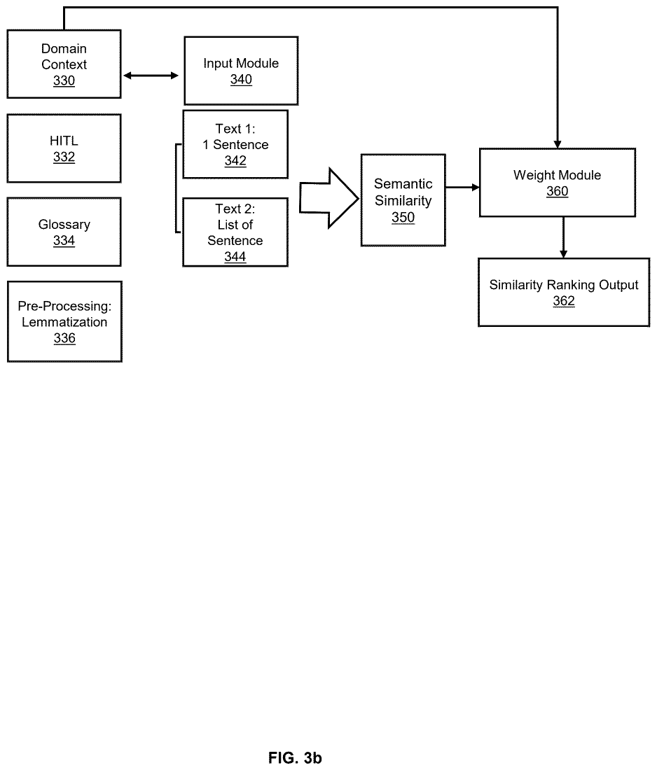

FIG. 3a provides a processing visualization of the flowchart of FIG. 2. Steps 210, 220, 230, 240 and 250 are provided as steps 310, 312, 314, 316 and 318, respectively. FIG. 3a provides a better visual explanation of how the scoring and ranking is used by displaying Scoring 1 (320), Scoring 2 (322) and Scoring 3 (324) components.

FIG. 3b, provides another block diagram that illustrates the components of FIG. 3a even in more detail. Domain specific context extracted after embedded model used for similarity analysis.

As was discussed before, Domain specific context 330 is used to extracted for inputs 340 and specifics text (such as in sentence 1 342 and list of sentences in 344). HITL—human in the loop 332, Glossary 334 (dictionary of terms or phrases pulled of similar meaning to each other such as synonyms etc.), will be included in domain context 330. Pre-Processing Lemmatization 336 is used to reduce words to their roots and include that in domain context as well.

A conceptual example of the Input Module can now be made. In this example for text 1 (sentence 1 at 342) the regulation states that an auto insurance policy cancellation notice will not be valid unless its due to nonpayment of premium or another specified reason. This process will then be analyzed for semantic similarly in 350.

In another example, text 2 (List of sentences 344) may include:
1. An insurance policy cancellation is valid without nonpayment of premium
2. A home insurance policy cancellation notice will not be valid unless it is due to nonpayment of premium
3. An auto insurance policy cancellation is not valid unless there is a specified reason.

Subsequently, the Weight module is applied at 360 and ranking is performed at 362, as shown.

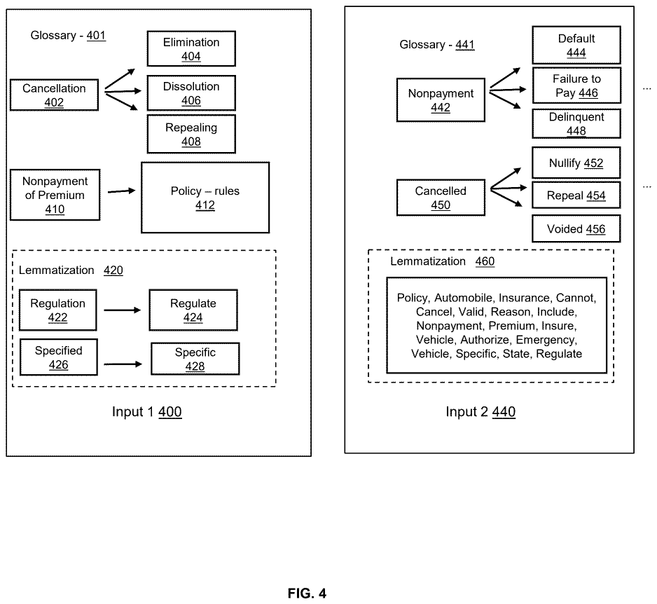

FIG. 4 is an illustration of a block diagram providing for a conceptual example of Domain Concept, according to one embodiment and as was briefly discussed in relation to Step 210. Input 1 referenced as 400, in this example, provides the regulation states that an auto insurance policy cancellation notice will not be valid unless it is due to nonpayment of premium or another specified reason. For Input 1 (400), glossary 401 is also provided that can include terms like cancellation and non-payment of premium with a corresponding action/consequence. For example, cancellation 402 can lead to elimination 404, dissolution 406 or repealing 408 of the policy. Similarly, non-payment of premium 410 can lead to 412—things such as the failure of the named insured to discharge any obligation in connection with the payment of premiums on a policy of insurance or any installment of such premium.

For Input 1 401, lemmatization 420 is also provided with corresponding regulations (422/424) and specified rules etc. (426/428) as shown.

For Input 2—specified as 440, in this example can be defined as a policy of automobile insurance cannot be cancelled without a valid reason, which includes nonpayment of premium, the insured vehicle being an authorized emergency vehicle, or other specific reasons as stated in the regulation. Input 2, 440, has similar structure as input 1 400. There is a glossary 441, and conditions such as nonpayment (442) that lead to default 444, failure to pay 446, and delinquency 448; as well as cancellation 450 that lead to nullification 452, repeal 454 and voiding actions 446. Lemmatization is provided at 460 which can include (462) such subcategories such as—Policy, Automobile, Insurance, Cannot, Cancel, Valid, Reason, Include, Nonpayment, Premium, Insure, Vehicle, Authorize, Emergency, Vehicle, Specific, State, Regulate.

FIG. 5 is a block diagram illustration of using Domain Context 510 to provide a Database embedding 530. A variety of code can be used to create a chroma DB for this embeddings, as shown at 520. An example is provided below:

```
chroma −= ChromaWithUpsert(
    Name = f”nq910_minilm6v2”,
    embedding_function=emb_func, # you can have something here using/embed
    endpoint
    persist_directory=knowledge_base_dir,
)
if chroma, is_empty( );
  _ =chroma,upsert_texts(
    texts = documents, indextext.tolist( ),
    #we handle tokenization/embedding/indexing automatically. Can skip/add own
    embeddings
    metadata = [{‘title’ “ title, “id”: id}
      for (title, id) in
      zip (documents, title, documents, id)}, # filter on these!
    ids = {str(i) for i in documents.id}, #unique for each doc
)
chroma.persist( )
```

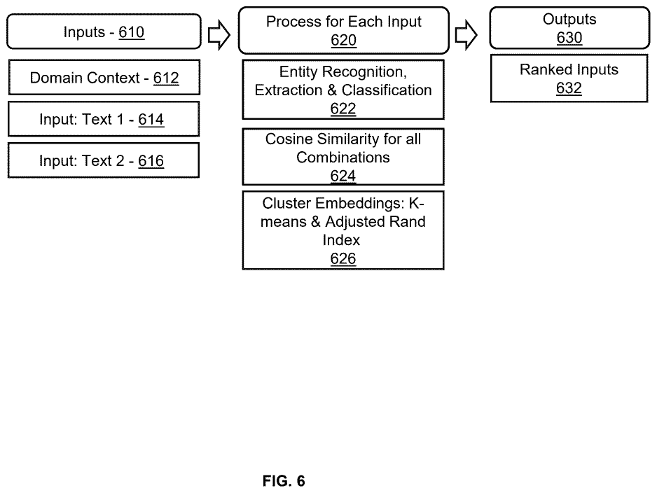

FIG. 6, provides a block diagram of a conceptual example of an instance dealing with a regulatory compliance regime, according to one embodiment. As discussed earlier, the Inputs 610 is obtained and through the Domain Context 612 and Input texts 612 and 614, information is extracted. In this embodiment the extracted information can be:
4. Obligations are extracted from regulatory datasets
5. Risks to be matched with are identified
6. Obligations dataset and risk dataset become inputs

The process for each Input is then provided and analyzed (620). This can involve the recognition and extraction as shown at 622, cosine similarity analysis as shown at 624 and cluster embeddings as shown at 626. In one embodiment, a more detailed list of information that is analyzed can be provided as follows:
Following each of the entity analysis steps on the process pipeline for each of the obligations and risks inputs;
Performing a cosine similarity for all obligation-to-risk combinations;
Creating cluster embeddings: K-means, get Z score and round them; then replace all positives with “high” and all negatives with “low” for similarity analysis; and
Computing an Adjusted Rand Index.

The Outputs 630 is then generated (with ranked Inputs 632 as discussed earlier). In one embodiment, this can include:
7. Appending all the results for each of the steps to each of the combination that matches to a data-frame; and
8. Ranking each of the obligations to risks identifying the best match of obligation-to-risk.

The processes discussed provide for techniques for Embodiments of the present invention disclose a method, computer system, and a computer program product for evaluating accuracy of a large language model (LLM). A user query is received, and a plurality of output is obtained that is generated by an LLM as a response to the user query. The accuracy of each output generated is determined by extracting domain context from the user query and each plurality of output generated by said LLM to generating at least a model input. The plurality of LLM outputs is compared to the at least one model input generated based on a semantic analysis. The plurality of LLM outputs is ranked for accuracy based on the comparison. The ranking is made based associated weights generated for each of the plurality of LLM outputs. A final response output is generated based on the ranking and a response is provided to the user query.

In one embodiment, the domain context includes a glossary, a lemmatization, and a human in the loop (HIIL) context data. It can also include errors obtained from previous mismatches that related to a similar server error or a debugging need recorded previously on another computer servers. The glossary comprises of a dictionary of terms or phrases pulled of similar meaning to each other, created for relevant terms in said LLM output. The weight module factors in a plurality of semantic similarity data to output a ranking of the most relevant to least relevant answers to the user query. The ranking is presented from a most relevant to least relevant in a descending order. The semantics comparison is made based on a cosine similarity of all combinations of a plurality of words and concepts and/or cluster embeddings of a computed RAND index.

The descriptions of the various embodiments of the present invention have been presented for purposes of illustration but may be not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for evaluating accuracy of a large language model (LLM) output, comprising:
receiving a user query;
obtaining a plurality of outputs generated by an LLM as a response to said user query;
determining accuracy of said plurality of outputs generated by said LLM by:
extracting domain context from said user query and said plurality of outputs generated by said LLM;
generating at least a model input based on said extracted domain contexts;
providing a semantic analysis and comparing said plurality of LLM outputs and said at least one model input;
ranking said plurality of LLM outputs based on comparison and analysis made between said at least one model input and each of said plurality of LLM outputs; wherein a weight is associated to each of said plurality of LLM outputs based on said comparison; and
generating a final response output based on said ranking so as to provide a response to said user query.

2. The method of claim 1, wherein said domain context includes a glossary, a lemmatization, and a human in the loop (HIIL) context data.

3. The method of claim 2, wherein said domain context also includes errors obtained from previous mismatches that related to a similar server error or a debugging need recorded previously on another computer servers.

4. The method of claim 2, wherein said glossary comprises of a dictionary of terms or phrases pulled of similar meaning to each other, created for relevant terms in said LLM output.

5. The method of claim 1, wherein said weight module factors in a plurality of semantic similarity data to output a ranking of the most relevant to least relevant answers to said user query.

6. The method of claim 1, wherein said ranking is presented from a most relevant to least relevant in a descending order.

7. The method of claim 1, wherein semantics comparison is made based on a cosine similarity of all combinations of a plurality of words and concepts and/or cluster embeddings of a computed RAND index.

8. A computer system for evaluating accuracy of a large language model (LLM), comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is enabled to perform the steps:
receiving a user query;
obtaining a plurality of outputs generated by an LLM as a response to said user query;
determining accuracy of said plurality of outputs generated by said LLM by:
extracting domain context from said user query and said plurality of outputs generated by said LLM;
generating at least a model input based on said extracted domain contexts;
providing a semantic analysis and comparing said plurality of LLM outputs and said at least one model input;
ranking said plurality of LLM outputs based on comparison and analysis made between said at least one model input and each of said plurality of LLM outputs; wherein a weight is associated to each of said plurality of LLM outputs based on said comparison; and
generating a final response output based on said ranking so as to provide a response to said user query.

9. The computer system of claim 8, wherein said domain context includes a glossary, a lemmatization, and a human in the loop (HIIL) context data.

10. The computer system of claim 9, wherein said domain context also includes errors obtained from previous mismatches that related to a similar server error or a debugging need recorded previously on another computer servers.

11. The computer system of claim 9, wherein said glossary comprises of a dictionary of terms or phrases pulled of similar meaning to each other, created for relevant terms in said LLM output.

12. The computer system of claim 9, wherein said weight module factors in a plurality of semantic similarity data to output a ranking of the most relevant to least relevant answers to said user query.

13. The computer system of claim 8, wherein said ranking is presented from a most relevant to least relevant in a descending order.

14. The computer system of claim 8, wherein semantics comparison is made based on a cosine similarity of all combinations of a plurality of words and concepts and/or cluster embeddings of a computed RAND index.

15. A computer program product for evaluating accuracy of a large language model (LLM), comprising:
one or more computer-readable storage media; and
program instructions stored on said one or more computer-readable storage media, comprising:
receiving a user query;
obtaining a plurality of outputs generated by an LLM as a response to said user query;
determining accuracy of said plurality of outputs generated by said LLM by:
extracting domain context from said user query and said plurality of outputs generated by said LLM;
generating at least a model input based on said extracted domain contexts;
providing a semantic analysis and comparing said plurality of LLM outputs and said at least one model input;
ranking said plurality of LLM outputs based on comparison and analysis made between said at least one model input and each of said plurality of LLM outputs; wherein a weight is associated to each of said plurality of LLM outputs based on said comparison; and
generating a final response output based on said ranking so as to provide a response to said user query.

16. The computer program product system of claim 15, wherein said domain context includes a glossary, a lemmatization, and a human in the loop (HIIL) context data.

17. The computer program product system of claim 16; wherein said domain context also includes errors obtained from previous mismatches that related to a similar server error or a debugging need recorded previously on another computer servers.

18. The computer program product system of claim 16, wherein said glossary comprises of a dictionary of terms or phrases pulled of similar meaning to each other, created for relevant terms in said LLM output.

19. The computer program product system of claim 15, wherein said weight module factors in a plurality of semantic similarity data to output a ranking of the most relevant to least relevant answers to said user query.

20. The computer program product system of claim 15, wherein semantics comparison is made based on a cosine similarity of all combinations of a plurality of words and concepts and/or cluster embeddings of a computed RAND index.
